(19) United States
(12) Patent Application Publication
(10) Pub. No.: US 2016/0062221 A1
(43) Pub. Date: Mar. 3, 2016

(54) ILLUMINATION OPTICAL SYSTEM AND PROJECTOR

(71) Applicant: NEC DISPLAY SOLUTIONS, LTD., Tokyo (JP)

(72) Inventor: Masateru Matsubara, Tokyo (JP)

(21) Appl. No.: 14/779,320

(22) PCT Filed: Jun. 4, 2013
(86) PCT No.: PCT/JP2013/065438

§ 371 Date: Sep. 22, 2015

(51) Int. Cl. G03B 21/20; H04N 9/31; G02B 5/30; G02B 27/28; G02B 26/00; G02B 27/14

(52) U.S. Cl. CPC G03B 21/204; G03B 21/2013; G03B 21/208; G02B 26/008; G03B 21/2066; G03B 21/2073; G02B 27/141; G02B 5/3083; G02B 27/283; G02B 5/3058; H04N 9/3111

(57) ABSTRACT

An illumination optical system is provided that is capable of reducing the saturation or reducing the emission intensity of a phosphor. The illumination optical system (10) includes: excitation light source (12) and phosphor unit (40). The excitation light source (12) includes a plurality of laser light sources (13) arranged in matrix form and emits excitation light realized by mixing the plurality of laser light beams emitted from the plurality of laser light sources (13). The phosphor unit (40) is provided with at least one phosphor area that, in response to the irradiation of the excitation light emitted from excitation light source (12), emits fluorescent light having a wavelength different from the wavelength of the excitation light. The excitation light is condensed on a phosphor unit (40) in a state in which the centers of the plurality of laser light beams emitted from the plurality of laser light source (13) are separated from each other.

### TECHNICAL FIELD

The present invention relates to an illumination optical system that is provided with a phosphor that emits fluorescent light by means of excitation light from a light source and to a projector that is provided with the illumination optical system.

### BACKGROUND ART

In recent years, light source devices have been developed that use phosphors that emit fluorescent light in response to the irradiation of excitation light as light sources for projectors. The light source devices disclosed in Japanese Unexamined Patent Application Publication No. 2012-108486 (hereinbelow referred to as Patent Document 1) and Japanese Unexamined Patent Application Publication No. 2012-212129 (hereinbelow referred to as Patent Document 2) each have an excitation light source that emits excitation light and a fluorescent wheel that is provided with phosphor areas that emit fluorescent light in response to the irradiation of the excitation light.

A fluorescent wheel includes a red phosphor area that emits fluorescent light of the red wavelength band, a green phosphor area that emits light of the green wavelength band, and a reflection area that reflects light. The fluorescent wheel is configured to allow rotation. By irradiating excitation light on a specific site of the fluorescent wheel while rotating the fluorescent wheel, the excitation light is sequentially irradiated upon the red phosphor area, the green phosphor area, and the reflection area. In this way, the fluorescent wheel sequentially emits red fluorescent light, green fluorescent light, and blue excitation light.

The excitation light source that emits the excitation light is made up of a plurality of laser diodes that emit laser light. All of the laser light that is emitted from the plurality of laser diodes is concentrated by a condensing lens on a small spot on the phosphor areas. In the light source devices described in Patent Document 1 and Patent Document 2, the aggregate of the laser light that is emitted from the plurality of laser diodes is adjusted to form a small spot having a diameter in the order of 2 mm on the fluorescent wheel.

### LITERATURE OF THE PRIOR ART

### Patent Documents

Patent Document 1: Japanese Unexamined Patent Application Publication No. 2012-108486
Patent Document 2: Japanese Unexamined Patent Application Publication No. 2012-212129

### SUMMARY OF THE INVENTION

### Problem to be Solved by the Invention

As disclosed in Patent Document 1 and Patent Document 2, when the aggregate of a plurality of laser light beams is condensed at one point on a phosphor layer, laser light of high intensity is irradiated upon a small area of the phosphor layer. When the intensity of excitation light that is irradiated upon phosphor is raised to a high level, a phenomenon occurs in which the light emission intensity of the phosphor is saturated or decreases. This phenomenon occurs because the irradiation of excitation light of high light intensity decreases the electrons that can be excited in the phosphor layer.

When excitation light of high intensity is further irradiated upon phosphor in a state in which the light emission intensity of the phosphor is in a saturated state, the excitation light energy that does not contribute to excitation of electrons in the phosphor layer is converted to heat, with the result that the temperature of the phosphor increases. The increase of the temperature of the phosphor results in a decrease of the conversion efficiency of excitation light to fluorescent light, and this results in the conversion of even more excitation light energy to heat. As a result of this process, the light emission intensity of the phosphor decreases.

It is an object of the present invention to provide an illumination optical system and projector in which the decrease or saturation of the light emission intensity of a phosphor can be reduced.

### Means for Solving the Problem

The illumination optical system in an exemplary embodiment of the present invention is provided with an excitation light source and a phosphor unit. The excitation light source includes a plurality of laser light sources that are arranged in matrix form and emits excitation light realized by mixing the plurality of laser light beams emitted from the plurality of laser light sources. The phosphor unit is provided with at least one phosphor area that, in response to the irradiation of excitation light that is emitted from the excitation light source, emits fluorescent light having a wavelength that differs from the wavelength of the excitation light. The excitation light is condensed on the phosphor unit in a state in which the centers of the plurality of laser light beams emitted from the plurality of laser light sources are in a mutually separated state.

The above-described configuration enables a reduction of the saturation or a decrease of the light emission intensity of a phosphor.

### BRIEF DESCRIPTION OF THE DRAWINGS

FIG. 1 shows the configuration of the illumination optical system in an exemplary embodiment of the present invention.

FIG. 2 is a plan view showing an example of the light source used in an illumination optical system.

FIG. 3 is a plan view showing an example of the phosphor unit used in an illumination optical system.

FIG. 4 shows the light intensity distribution of excitation light on the phosphor unit in the absence of a diffuser.

FIG. 5 shows the light intensity distribution of excitation light on a phosphor unit when a diffuser is present.

FIG. 6 shows the optical transmittance of a dichroic mirror that is used in an optical system.

FIG. 7 shows the configuration of a projector that includes the illumination optical system shown in FIG. 1.

### BEST MODE FOR CARRYING OUT THE INVENTION

Exemplary embodiments of the present invention are next described with reference to the accompanying drawings.

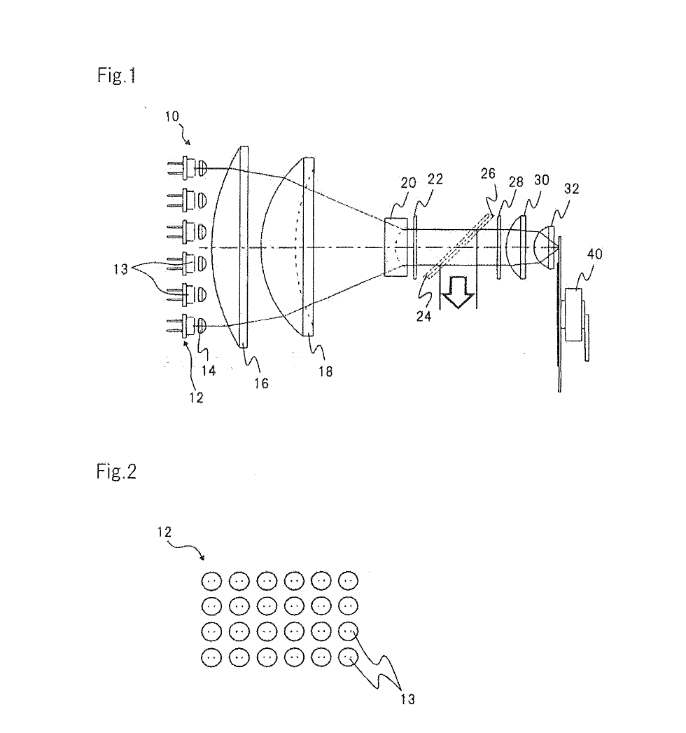

FIG. 1 shows the configuration of the illumination optical system in an exemplary embodiment of the present invention. Illumination optical system 10 is provided with excitation light source 12 that emits excitation light; and phosphor unit 40 that incudes a phosphor that emits fluorescent light in response to the irradiation of excitation light.

Excitation light source 12 includes a plurality of laser light sources 13 that are arranged in matrix foim. Excitation light source 12 emits excitation light that is formed by mixing the laser light emitted from the plurality of laser light sources 13. Excitation light source 12 emits the excitation light toward phosphor unit 40.

As shown in FIG. 2, the plurality of laser light sources 13 are preferably arranged in matrix form on the same plane. Laser diodes can be used as the laser light sources 13. In FIG. 2, the plurality of laser light sources 13 are arranged in matrix form of four rows and 6 columns. The present invention is not limited to this arrangement, and the number and arrangement of the laser light sources 13 can be freely selected as appropriate according to the desired output value.

In the present exemplary embodiment, each laser light source 13 emits laser light of the blue wavelength range. The present invention is not limited to this form, and each laser light source 12 may be any component that can emit excitation light that excites a phosphor.

FIG. 3 shows an example of phosphor unit 40. In this example, phosphor unit 40 has reflection area 41 that reflects excitation light and phosphor areas 42a, 44a, 46a, 42b, 44b, and 46b that, in response to irradiation of the excitation light, emit fluorescent light having wavelengths that differ from the wavelength of the excitation light.

Reflection area 41 reflects excitation light that is emitted from excitation light source 12. Phosphor areas 42a, 44a, 46a, 42b, 44b, and 46b each may be made up of a phosphor that is applied to a mirror surface. These phosphors emit fluorescent light in substantially the same direction as the reflection direction of the excitation light in reflection area 41.

In the example shown in FIG. 3, phosphor unit 40 includes first phosphor areas 42a and 42b, second phosphor areas 44a and 44b, and third phosphor areas 46a and 46b. In first phosphor areas 42a and 42b, a phosphor is provided that, in response to irradiation of the excitation light (blue laser light) emits light of the red wavelength that is longer than the wavelength of the excitation light. In the second phosphor areas 44a and 44b, a phosphor is provided that, in response to irradiation of the excitation light (blue laser light) emits light of the green wavelength that is longer than the wavelength of the excitation light. In the third phosphor areas 46a and 46b, a phosphor is provided that, in response to irradiation of the excitation light (blue laser light) emits light of the yellow wavelength that is longer than the wavelength of the excitation light.

The surface of phosphor unit 40 on which phosphor areas 42a, 44a, 46a, 42b, 44b, and 46b are formed may be configured so as to be rotatable around center 48. First phosphor areas 42a and 42b, second phosphor areas 44a and 44b, third phosphor areas 46a and 46b, and reflection area 41 are aligned in order along this direction of rotation.

The excitation light that is emitted from excitation light source 12 is irradiated upon a specific area 49 of phosphor unit 40. In contrast, phosphor unit 40 is movable such that excitation light from excitation light source 12 is sequentially irradiated upon phosphor areas 42a, 44a, 46a, 42b, 44b, and 46b and reflection area 41. More specifically, phosphor unit 40 is rotationally driven by a motor. In this way, red fluorescent light, green fluorescent light, yellow fluorescent light, and blue laser light are sequentially emitted from phosphor unit 40.

The configuration of phosphor unit 40 is not limited to this form and is open to various modifications. Phosphor unit 40 should have at least one phosphor area. Further, an illumination optical system that emits light of various colors can be realized if phosphor unit 40 includes a plurality of phosphor areas that, in response to the irradiation of excitation light, emit fluorescent light having mutually different wavelengths. The phosphor unit shown in FIG. 3 can realize full-color light. Further, full-color light can be realized even if phosphor unit 40 does not include phosphor areas 46a and 46b that emit yellow fluorescent light. The wavelength of the fluorescent light emitted from each phosphor area is selected as appropriate according to the use of illumination-optical system 10.

Illumination optical system 10 preferably has optical systems 24, 26, and 28 that bend the paths of fluorescent light that is emitted from phosphor areas 42a, 44a, 46a, 42b, 44b, and 46b and the path of excitation light that is reflected at reflection area 41 in a direction that differs from the position of excitation light source 12. These optical systems 24, 26, and 28 are provided between excitation light source 12 and phosphor unit 40.

The excitation light that is emitted from excitation light source 12 passes through optical systems 24, 26, and 28 to reach phosphor unit 40. On the other hand, the fluorescent light that is emitted from phosphor areas 42a, 44a, 46a, 42b, 44b, and 46b and the excitation light that is reflected at reflection area 41 are reflected by the elements that make up optical systems 24, 26, and 28 and travel in the direction of the arrow of FIG. 1.

According to necessity, illumination optical system 10 may for example also include collimator lenses 14, reducing optical systems 16, 18, and 20, condensing optical systems 30 and 32, and diffuser 22.

The laser light discharged from each laser light source 13 is converted to quasi-parallel light by collimator lenses 14. Mixing of the laser light that has been converted to quasi-parallel light results in quasi-parallel light for small spatial distribution of the optical intensity of laser light beams by means of reducing optical systems 16, 18, and 20. In FIG. 1, the reducing optical system is made up of three lenses 16, 18, and 20, but the number of lenses of the reducing optical system can be freely changed.

Laser light that has passed through reducing optical systems 16, 18 and 20, passes through diffuser 22 that is provided between excitation light source 12 and phosphor unit 40 that are on the optical path of excitation light. Laser light that has passed through diffuser 22 passes through optical systems 24, 26, and 28 and condensing optical systems 30 and 32 and is irradiated onto phosphor unit 40. In addition, illumination optical system 10 need not include diffuser 22.

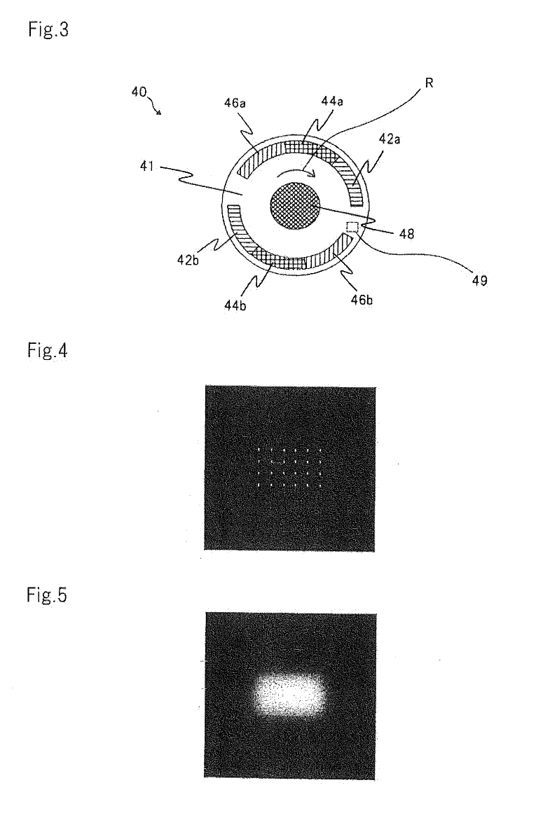

FIG. 4 shows the optical intensity distribution of excitation light on phosphor unit 40 in the absence of diffuser 22. FIG. 5 shows the optical intensity distribution of excitation light on phosphor unit 40 when diffuser 22 is present. The white area of FIGS. 4 and 5 are areas in which the optical intensity is strong.

The centers of the laser light beams that are emitted from the plurality of laser light sources 13 are separated from each other and are not concentrated at one point on phosphor unit 40. In other words, the excitation light is condensed on phosphor unit 40 in a state in which the centers of the laser light beams emitted from the plurality of laser light sources 13 are separated from each other. The centers of the laser light beams are the places where the optical intensity is highest in the spatial distribution of the optical intensity of each laser light beam.

To explain in greater detail, as shown in FIG. 4, a plurality of peaks in optical intensity that accord with the number and positions of the laser light sources 13 are shown on phosphor unit 40. In other words, luminance distribution that accords with the arrangement of the plurality of laser light sources 13 is realized on phosphor unit 40.

Compared to a case in which the centers of the laser light beams are concentrated at one point, the intensity (maximum intensity) of the excitation light that is irradiated on a specific area of the phosphor area can be decreased by mutually shifting the centers of luminous flux of each laser light beam as described above. The saturation or decrease of the light emission intensity of the phosphor in the specific area can thus be reduced.

On the other hand, when diffuser 22 is present, the overall intensity distribution of the excitation light in which the plurality of laser light beams are mixed can be made uniform (see FIG. 5). Diffuser 22 decreases the intensity peak of each laser light beam, and moreover, causes the distribution of intensity of the excitation light that is realized by the mixing of the plurality of laser light beams to reach a uniform distribution state (top-hat distribution). Even in this case, there is no difference from a state in which the centers of the laser light beams emitted from each of laser light sources 13 are mutually shifted. In this case as well, luminance distribution that accords with the arrangement of the plurality of laser light sources 13 may be realized on phosphor unit 40.

Diffuser 22 causes the intensity distribution of the excitation light to become substantially uniform within the range of the spread of excitation light, and the intensity (maximum intensity) of excitation light that is irradiated on a specific minute area of the phosphor area is further decreased. As a result, the saturation or decrease of the light emission intensity that accompanies the diminution of excitable electrons in the phosphor can be further reduced.

In addition, rotating the disk on which phosphor areas 42a, 44a, 46a, 42b, 44b, and 46b are formed prevents constant irradiation of the excitation light upon the same sites of phosphor areas 42a, 44a, 46a, 42b, 44b, and 46b and therefore enables reduction of the increase of the temperature of the phosphors.

Details regarding optical systems 24, 26, and 28 that are provided between excitation light source 12 and phosphor unit 40 are next described. These optical systems include reflective polarizing element 24, dichroic mirror 26, and quarter-wave plate 28.

Reflective polarizing element 24 is provided on the optical path of excitation light that is emitted from excitation light source 12 and excitation light that is reflected at reflection area 41. Reflective polarizing element 24 transmits light of a first linear polarization and reflects light of a second linear polarization that is orthogonal to the first linear polarization. Typically, light of the first linear polarization is P-polarized light or S-polarized light, and light of the second linear polarization is the remaining P-polarized light and S-polarized light. Reflective polarizing element 24 may be a reflective polarizing plate having a translucent substrate with metal fine lines formed on one surface of the translucent substrate.

Dichroic mirror 26 is on the optical path of the excitation light and is provided between excitation light source 12 and phosphor unit 40. More preferably, dichroic mirror 26 is provided between reflective polarizing element 24 and phosphor unit 40.

Dichroic mirror 26 transmits light within the wavelength range of excitation light that is emitted from excitation light source 12 and reflects light within the wavelength ranges of fluorescent light emitted from phosphor areas 42a, 44a, 46a, 42b, 44b, and 46b of phosphor unit 40. In addition, dichroic mirror 26 transmits both P-polarized light excitation light and S-polarized light excitation light.

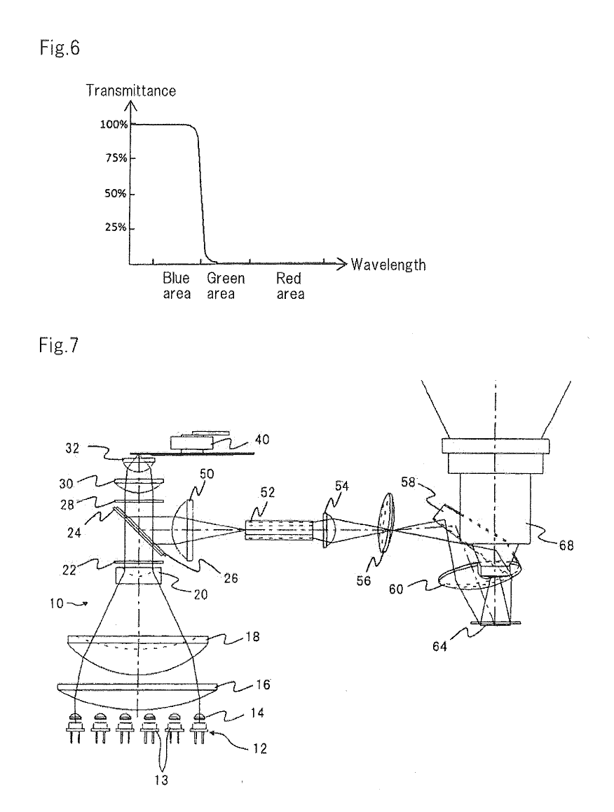

When the excitation light that is emitted from excitation light source 12 has the wavelength of blue, dichroic mirror 26 preferably has the transmission properties shown in FIG. 6. More specifically, dichroic mirror 26 has the characteristics of transmitting light of the blue wavelength range and reflecting visible light outside the blue wavelength range (red light, yellow light, and green light).

Dichroic mirror 26 may be a dielectric multilayered film mirror. In this case, dichroic mirror 26 includes a translucent substrate and a dielectric multilayered film that is formed on one surface of the translucent substrate.

Quarter-wave plate 28 is on the optical path of excitation light and is provided between reflective polarizing element 24 and phosphor unit 40, and more preferably, between dichroic minor 26 and phosphor unit 40.

The optical paths of excitation light that is emitted from excitation light source 12 and the excitation light emitted to phosphor areas 42a, 44a, 46a, 42b, 44b, and 46b are next described. Here, laser light source 13 is assumed to emit blue laser light. The excitation light emitted from excitation light source 12 is realized by mixing a plurality of blue laser light beams that are emitted from the plurality of laser light sources 13. This blue excitation light passes through reducing optical systems 16, 18, and 20 and is irradiated into reflective polarizing element 24. Here, the reflecting surface of reflective polarizing element 24 is preferably inclined at an angle of approximately 45 degrees with respect to the direction of travel of the excitation light.

In the present example, reflective polarizing element 24 has the property of transmitting P-polarized light and reflecting S-polarized light. Accordingly, the P-polarized light component of blue excitation light that is emitted from excitation light source 12 passes through reflective polarizing element 24. Here, the plurality of laser light sources 13 preferably emit laser light having only the P-polarized light component. In this case, virtually all of the blue excitation light passes through reflective polarizing element 24. Decrease of the utilization efficiency of the illumination optical system is thus prevented.

The blue excitation light that has passed through reflective polarizing element 24 is irradiated into dichroic mirror 26. The reflecting surface of dichroic minor 26 is preferably inclined at an angle of approximately 45 degrees with respect to the direction of travel of the excitation light. As noted hereinabove, dichroic mirror 26 transmits light within the wavelength range of the excitation light that is emitted from excitation light source 12.

The blue excitation light that has passed through dichroic minor 26 is irradiated onto quarter-wave plate 28. The state of the blue excitation light that is irradiated into quarter-wave plate 28 changes from P-polarized light to circularly polarized light. The blue excitation light whose state has changed to circularly polarized light is condensed on irradiation area 49 of phosphor unit 40 by condensing optical systems 30 and 32 (see also FIG. 3). In FIG. 1, condensing optical systems 30 and 32 are made up of two lenses, but the number of lenses of the condensing optical systems is open to modification.

Due to diffuser 22, the light intensity distribution of the blue excitation light that is condensed on phosphor unit 40 reaches a distribution state such as shown in FIG. 5. When diffuser 22 is absent, the light intensity distribution of the blue excitation light condensed on phosphor unit 30 is in a distribution state such as shown in FIG. 4.

By means of the irradiation of blue excitation light, red fluorescent light, green fluorescent light, yellow fluorescent light, and blue light (blue excitation light) are sequentially emitted from phosphor unit 40. The fluorescent light emitted from phosphor areas 42a, 44a, 46a, 42b, 44b and 46b is randomly polarized light in a state close to perfect diffusion. After having been converted to quasi-parallel light by lens systems 32 and 30, this fluorescent light passes through quarter-wave plate 28. In addition, the blue light that is reflected at reflection area 41 is converted to quasi-parallel light by lens systems 32 and 30 and then passes through quarter-wave plate 28.

The red, green, and yellow fluorescent light maintains the randomly polarized state despite passage through quarter-wave plate 28. On the other hand, quarter-wave plate 28 converts the blue excitation light from circularly polarized light to S-polarized light. The fluorescent light of each color and the blue excitation light that have passed through quarter-wave plate 28 are irradiated into dichroic mirror 26.

As described hereinabove, dichroic mirror 26 reflects light belonging to the wavelength ranges of the fluorescent light that has been emitted from phosphor areas 42a, 44a, 46a, 42b, 44b and 46b. As a result, the red, green, and yellow fluorescent light advances in the direction of the arrow shown in FIG. 1.

As described hereinabove, dichroic mirror 26 transmits blue excitation light. The blue excitation light that has passed through dichroic mirror 26 is irradiated into reflective polarizing element 24.

Reflective polarizing element 24 reflects S-polarized light, and the blue excitation light is therefore reflected at reflective polarizing element 24. The blue excitation light that has been reflected by reflective polarizing element 24 passes through dichroic mirror 26 and travels in the direction of the arrow shown in FIG. 1. Here, the direction of travel of the blue excitation light that is reflected at reflective polarizing element 24 is substantially the same direction as the direction of travel of the fluorescent light that is reflected at dichroic minor 26.

The excitation light reflected at reflection area 41 passes along substantially the same optical path as the fluorescent light that was emitted from phosphor areas 42a, 44a, 46a, 42b, 44b and 46b and is emitted from illumination optical system 10. In this way, the excitation light and fluorescent light that are emitted from phosphor unit 40 pass along substantially the same optical path and are emitted from illumination optical system 10, whereby the need to provide separate optical systems for each wavelength of light is eliminated. As a result, the number of constituent elements of illumination optical system 10 is decreased and the size of illumination optical system 10 can be reduced.

The reflecting surface of reflective polarizing element 24 is preferably arranged adjacent and substantially parallel to the reflecting surface of dichroic mirror 26. In this way, the blue excitation light and the fluorescent light of each color can be emitted in substantially the same direction.

When reflective polarizing element 24 is the above-described reflective polarizing plate, and moreover, when the dichroic minor is the above-described dielectric multilayered film mirror, the surface on which metal thin lines are formed (wire grid surface) of the translucent substrate of the reflective polarizing plate is preferably opposite to the surface on which the dielectric multilayered film is formed of the translucent substrate of dichroic minor 26. Further, the wire grid surface of the reflective polarizing plate is preferably arranged adjacent and substantially parallel to the reflecting surface of dichroic mirror 26. This arrangement has the advantage of minimizing the difference in optical path between the blue light that is reflected at reflection area 41 and the red, green, and yellow fluorescent light emitted from the phosphor areas.

In Patent Document 2, one dichroic mirror is used that has the characteristics of transmitting the excitation light emitted from the excitation light source and reflecting the excitation light reflected at the reflection area. In this way, the blue excitation light that is reflected at the reflection area is reflected in a direction that differs from the excitation light source. To realize this action, the dichroic minor transmits light of a wavelength range that is sufficiently smaller than 445 nm for S-polarized light, reflects light of a wavelength range that is equal to or greater than 445 nm for S-polarized light, transmits light of a wavelength range that is equal to or less than approximately 445 nm for P-polarized light, and reflects light of a wavelength range that is sufficiently greater than 445 nm for P-polarized light. More specifically, the dichroic mirror described in Patent Document 2 has a cut-off wavelength of 434 nm for S-polarized light and a cut-off wavelength of 456 nm for P-polarized light. The cut-off wavelength (also referred to as the half-wavelength) here described is the wavelength at which the transmittance of light that passes through a dichroic mirror becomes 50%. At this time, the wavelength of the excitation light emitted from the excitation light source must be a value between the two cut-off wavelengths.

In the light source device disclosed in Patent Document 2, the wavelength of blue excitation light needs to be sufficiently separated from the two cut-off wavelengths of the dichroic mirror in order to prevent decrease of the light utilization efficiency of the excitation light. This necessity arises because a dichroic mirror does not have sufficiently high transmittance or sufficiently high reflectance with respect to light of a wavelength range in the vicinity of a cut-off wavelength. Accordingly, from the standpoint of providing an illumination optical system that can emit bright illumination light having high light utilization efficiency, the wavelength of blue excitation light is preferably separated by approximately 25 nm from both the cut-off wavelength for S-polarized light and the cut-off wavelength for P-polarized light of the dichroic mirror. As a result, the dichroic mirror preferably has the characteristic that the cut-off wavelength of P-polarized light and the cut-off wavelength of S-polarized light are separated by at least 50 nm. Nevertheless, a dielectric multilayered film mirror having the characteristic in which the cut-off wavelength of P-polarized light and the cut-off wavelength of S-polarized light are separated by approximately 50 nm is extremely difficult to realize.

As shown in FIG. 1, blue excitation light that is reflected at reflection area 41 in the present invention is reflected in a direction that differs from excitation light source 12 by reflective polarizing element 24 and not by dichroic mirror 26. Accordingly, there is no need to use a special dichroic mirror in which the transmission/reflection characteristics greatly differ according to the polarization component. The cut-off wavelengths of dichroic mirror 26 should be nearly the same values for S-polarized light and P-polarized light.

In illumination optical system 10 shown in FIG. 1, a dichroic prism having an organic material such as an adhesive is unnecessary. An organic material can be burned by laser light having strong light intensity. In the present invention, an illumination optical system is adopted that does not employ this type of dichroic prism, and a construction can therefore be adopted that does not use organic materials. In this case, laser light sources 13 that emit laser light of strong light intensity can be used.

In the above-described example, an explanation is provided that concerns to the case of excitation light source 12 that emits blue laser light that contains a P-polarized light component and reflective polarizing element 24 that has the characteristic of transmitting P-polarized light and reflecting S-polarized light. If possible, this configuration may be changed to a configuration that uses excitation light source 12 that emits excitation light that contains an S-polarized light component and reflective polarizing element 24 having the characteristic of transmitting S-polarized light and reflecting P-polarized light.

A projector in an exemplary embodiment of the present invention is next described with reference to FIG. 7. The projector is equipped with illumination optical system 10 shown in FIG. 1. As described above, illumination optical system 10 sequentially emits red light, green light, yellow light, and blue light. The light emitted from illumination optical system 10 is condensed on the incident-side end of light tunnel 52 by condensing lens 50. Light tunnel 52 converts the incident light to light having a uniform substantially square illuminance distribution.

The light emitted by light tunnel 52 passes through lenses 54 and 56 and is reflected by mirror 58. The light reflected by mirror 58 passes through lens 60 and is then enlarged and illuminated on image forming element 64. At this time, the uniform illuminance distribution of light is maintained at the emission-side end of light tunnel 52.

A reflective display element can be used as image forming element 64. The reflective display element may be, for example, a digital micromirror device (DMD). The DMD adjusts the quantity of light according to each color for each pixel. The light that has undergone adjustment of light quantity (the image light) is enlarged and projected onto a screen by way of projection lens 68.

More specifically, the DMD has minute mirror elements of the same number as the number of pixels. Each mirror element is constructed to allow rotation by a prescribed angle around an axis of rotation. Light that is irradiated into a mirror element inclined in a particular direction is reflected in the direction in which projection lens 68 is arranged. Light that is irradiated into projection lens 68 is projected outside the projector. Light that is irradiated into minor elements that are inclined in another direction is reflected in a direction in which projection lens 68 is not arranged. In this way, each individual mirror element selects whether or not light corresponding to each pixel is guided to projection lens 68 or not. By implementing this control over the light of each color by the DMD, the projector is capable of displaying a color image through projection lens 68 and onto a screen.

A reflective image forming element, and more specifically, a DMD, is used in the projector of the present exemplary embodiment. However, a transmissive image forming element can also be used in place of the reflective image foaming element as image forming element 64. A liquid crystal panel (LCD) can be used as the image forming element.

Although preferable exemplary embodiments of the present invention have been presented and details described, the present invention is not limited to the above-described exemplary embodiments and it is to be understood that the present invention can be variously modified and amended within a range that does not depart from the gist of the present invention.

### EXPLANATION OF REFERENCE NUMBERS

10 illumination optical system
12 excitation light source
13 laser light source
22 diffuser
24 reflective polarizing element
26 dichroic mirror
40 phosphor unit
41 reflection area
42a, 42b first phosphor area
44a, 44b second phosphor area
46a, 46b third phosphor area
49 irradiation area
64 image forming element
68 projection lens

1. An illumination optical system comprising:
an excitation light source that includes a plurality of laser light sources that are arranged in matrix form and that emit excitation light realized by mixing the plurality of laser light beams emitted from said plurality of laser light sources; and
a phosphor unit that is provided with at least one phosphor area that, in response to the irradiation of said excitation light that is emitted from said excitation light source, emits fluorescent light having a wavelength that differs from the wavelength of said excitation light;
wherein said excitation light is condensed on said phosphor unit in a state in which the centers of the plurality of laser light beams emitted from the plurality of laser light sources are in a mutually separated state.

2. The illumination optical system as set forth in claim 1, further comprising:
a diffuser that is provided on the optical path of said excitation light between said excitation light source and said phosphor unit and that causes the intensity distribution of said excitation light to reach a state of uniform distribution.

3. The illumination optical system as set forth in claim 1, wherein:
said phosphor unit includes a plurality of phosphor areas that emit fluorescent light having mutually differing wavelengths; and
said phosphor unit is movable such that said excitation light from said excitation light source sequentially irradiates each of said plurality of phosphor areas.

4. The illumination optical system as set forth in claim 1, wherein:
said phosphor unit further includes a reflection area that reflects said excitation light;
said phosphor unit is movable such that said excitation light from said excitation light source sequentially irradiates said phosphor areas and said reflection area; and
an optical system that bends the path of travel of fluorescent light that is emitted from said phosphor areas and the path of travel of said excitation light that is reflected by said reflection area in a direction that differs from the position of said excitation light source is provided between said light source and said phosphor unit.

5. The illumination optical system as set forth in claim 4,
wherein said optical system includes:
a reflective polarizing element that transmits light of a first linear polarization and reflects light of a second linear polarization that is orthogonal to said first linear polarization;
a dichroic mirror that transmits light within the wavelength range of said excitation light and that reflects light within the wavelength range of said fluorescent light that is emitted from said phosphor in substantially the same direction as the direction of travel of said excitation light that is reflected by said reflective polarizing element after having been reflected by said reflection area; and
a quarter-wave plate that is provided between said reflective polarizing element and said phosphor unit.

6. The illumination optical system as set forth in claim 5, wherein said excitation light source emits excitation light of said first linear polarization.

7. The illumination optical system as set forth in claim 5, wherein the reflecting surface of said reflective polarizing element is arranged adjacent and substantially parallel to the reflecting surface of said dichroic mirror.

8. The illumination optical system as set forth in claim 5, wherein:
said dichroic mirror includes a first translucent substrate, and a dielectric multilayered film that is formed on one surface of the first translucent substrate;
said reflective polarizing element includes a second translucent substrate, and metal fine lines that are formed on one surface of the second translucent substrate; and
film is formed is opposite to the surface of said second translucent substrate on which said metal fine lines are formed.

9. The illumination optical system as set forth in claim 5, wherein:
said excitation light source emits excitation light belonging to the blue wavelength range;
said phosphor areas emit visible light having longer wavelengths than the wavelength range of said excitation light; and
said dichroic mirror has the characteristic of transmitting light of the blue wavelength range and reflecting visible light other than the blue wavelength range.

10. A projector that is provided with the illumination optical system as set forth in claim 1.
